(19) United States
(12) Patent Application Publication
(10) Pub. No.: US 2025/0283490 A1
(43) Pub. Date: Sep. 11, 2025

(54) MANIFOLD DESIGN FOR UNIFORM FLOW

(71) Applicant: The Board of Trustees of the University of Illinois, Urbana, IL (US)

(72) Inventors: Kyle C. Smith, Champaign, IL (US); Vu Quoc Do, Urbana, IL (US); Irwin C. Loud, IV, Oak Park, IL (US); Md Habibur Rahman, Urbana, IL (US); Colby Warden, Urbana, IL (US)

(21) Appl. No.: 18/743,616

(22) Filed: Jun. 14, 2024

Related U.S. Application Data
(60) Provisional application No. 63/613,289, filed on Dec. 21, 2023.

(51) Int. Cl. F15D 1/00

(52) U.S. Cl. CPC F15D 1/001

(57) ABSTRACT

A manifold for providing a uniform flow velocity of a fluid is disclosed. The manifold includes a header channel that includes a port to receive the fluid and a triangular-shaped diffuser. The triangular-shaped diffuser includes a plurality channels, each of which is in fluid communication with one of a plurality of openings of the header channel. Each of the channels terminate at a distal opening on an outlet plane. The length of each channel varies linearly based on its position along a length of the header channel. A downstream-most location of the header channel intersects the outlet plane at an angle ϕ. The header channel and the triangular-shaped diffuser are configured to provide a uniform flow velocity at the outlet zone during fluid flow. The manifold provides for a compact design while ensuring uniform flow velocity.

### RELATED APPLICATIONS

The present application claims the benefit of priority of U.S. Provisional Patent Application No. 63/613,289, filed Dec. 21, 2023, which is hereby incorporated by reference in its entirety.

### FEDERALLY SPONSORED RESEARCH OR DEVELOPMENT

The present application was made with government support under N00014-22-1-2577 awarded by the U.S. Navy (Office of Naval Research). The government has certain rights in the invention.

### BACKGROUND

Manifolds are used to route fluids in a diversity of applications including but not limited to heat exchange, electrochemistry, and medical devices. For the efficient and effective operation of all such systems, uniform delivery of fluids to all output channels of the manifold is desirable to maximize process efficiency and productivity. While various manifold architectures have been developed previously, most can be grouped into two categories: header-based manifolds and header-less manifolds, where a header constitutes a single channel designed to distribute an inflow into a multiplicity of outflows.

The most common header-less manifold, the bifurcating manifold, simply divides the inflow into two outflows, thus requiring multiple bifurcating generations to achieve more than two outflows. By minimizing the work required for a fluid to bifurcate in such manifolds, an optimal configuration of bifurcating branches results when the ratio of the diameters of successive generations is fixed at

$$1 / \sqrt[3]{2} = 0.793 .$$

Such manifolds produce highly uniform flows among outlet channels. However, their streamwise extent must be the same order of magnitude as the manifold's width because the streamwise extent of each generation contributes to total extent.

The most common header-based manifolds are used in pairs with Z-type, U-type, and Y-type arrangements, the difference between each type being the location of the inlet port with respect to the outlet port in the inlet and outlet headers. In principle, header-based manifolds have the potential to be more compact than bifurcating manifolds, owing to their use of a direct path between the manifold's inlet feed and its outlet plane. While such manifolds promise smaller footprints than bifurcating manifolds, flow uniformity is often compromised to achieve it unless a judicious design of header geometry is used, especially if a header is used individually instead of being used in a paired arrangement. This tradeoff is readily illustrated for the triangular Hele-Shaw-type manifolds that are commonly used in filter-press electrochemical flow cells and in microchannel heat exchangers. Such manifolds produce non-uniform outlet velocity in general, and the degree of flow non-uniformity is exacerbated for those manifolds having small streamwise extent, thus motivating strategies to uniformize flow using a manifold with a small footprint.

### SUMMARY

The present disclosure describes a manifold which provides a uniform flow of fluid. In some embodiments, the manifold comprises a header channel and a triangular-shaped diffuser. The header channel includes a port configured to receive a fluid and includes a plurality of openings disposed away from the port. The triangular-shaped diffuser includes a plurality of channels. Each channel is in fluid communication with one of the openings of the header channel and extends to a distal opening that terminates at an outlet plane. The channel length of the plurality of channels vary linearly along a length of the header channel. The downstream-most location of the header channel intersects the outlet plane at angle ϕ. The header channel and the triangular-shaped diffuser are configured to provide a uniform flow velocity of the fluid at the outlet zone during fluid flow.

In some embodiments, the manifold comprises a header channel and a triangular-shaped diffuser. The header channel includes a port and includes a plurality of openings disposed away from the port. The header channel has a tapered cross-section along a length of the header channel. The triangular-shaped diffuser includes a plurality of channels. Each channel is in fluid communication with one of the openings of the header channel and extends to a distal opening that terminates at an outlet plane. The channel length of the plurality of channels vary linearly along a length of the header channel. The downstream-most location of the header channel intersects the outlet plane at angle ϕ.

In some embodiments, the manifold comprises a header channel and a triangular-shaped diffuser. The header channel includes a port and includes a plurality of openings disposed away from the port. The header channel has a tapered cross-section along a length of the header channel. The triangular-shaped diffuser includes a porous material that provides flow pathways therethrough and has a permeability k_{d}. The porous material is in fluid communication with the openings of the header channel and terminates at an outlet plane. The downstream-most location of the header channel intersects the outlet plane at angle ϕ.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments of the present disclosure may be better understood with reference to the following drawings and description. The components in the figures are not necessarily to scale, with emphasis instead placed upon illustrating the principles of the present disclosure. Moreover, in the figures, like reference numerals are generally used to designate similar or identical features.

FIG. 1 is a plan view of an embodiment of a manifold according to this disclosure.

FIG. 2 is a graphical representation of width and pressure variation along the length of an exemplary tapered header.

FIGS. 3A-3C are plan views of additional embodiments of a manifold according to this disclosure.

FIG. 4 shows a computer aided design (CAD) model for an exemplary manifold having a tapered header and a triangular diffuser (TH-TD).

FIG. 5A is a line drawing of the manifold of FIG. 4.

FIG. 5B is a line drawing of a comparative manifold having a straight header and a triangular diffuser (SH-TD).

FIG. 5C is a line drawing of a comparative manifold having a straight header and a rectangular diffuser (SH-RD) with L_{d}=10 mm.

FIG. 5D is a line drawing of a comparative manifold having a straight header and a rectangular diffuser (SH-RD) with L_{d}=2.5 mm.

FIGS. 6A-6D show experimental, simulated, and theoretical distributions of normalized diffuser velocity and pressure for Re≈1.6 as a function of position for the manifolds of FIGS. 5A-5D, respectively.

FIG. 7 shows simulation results showing pressure and velocity contours with Re≈0.1 for (a) a uniformizing, TH-TD manifold, (b) a SH-TD manifold, and (c) a SH-RD manifold, where the highlighted lines superimposed on pressure fields show isobars with uniform spacing; pressure values are normalized by the inlet pressure pᵢₙ, and velocity values are normalized by the maximum axial velocity max (u_{y}) in the center channel.

FIG. 8A shows experimental diffuser-velocity distributions at Re≈8 for a uniformizing, TH-TD manifold and two SH-RD manifolds with respective diffuser channel lengths of L_{d}=10 mm and L_{d}=2.5 mm.

FIG. 8B shows maximum deviations of the experimental velocities from the average velocity at different Reynolds numbers for a TH-TD manifold, an SH-TD manifold, and two SH-RD manifolds.

FIG. 8C shows simulated and experimental maximum normalized velocity deviations for the TH-TD manifold, as a function of Reynolds number.

FIG. 9 shows, for the TH-TD manifold, normalized flow rate versus normalized position for flow of different Reynolds numbers.

FIGS. 10A-10D show experimental, simulated, and theoretical distributions of normalized diffuser velocity and pressure as a function of position at Re≈0.1 for varied joint radii between the header channel opening and channel of the diffuser.

### DETAILED DESCRIPTION

The present disclosure describes a compact uniformizing manifold with a header design that may enable at least a four-fold smaller streamwise extent than existing bifurcating manifolds. The disclosed manifold may provide uniform flow in the low Reynolds-number limit using a diffuser comprised of straight, parallel channels arrayed within a triangular-shaped boundary. The diffuser may be attached to or integrally formed with a tapered header which is designed to produce a linear pressure drop along its length.

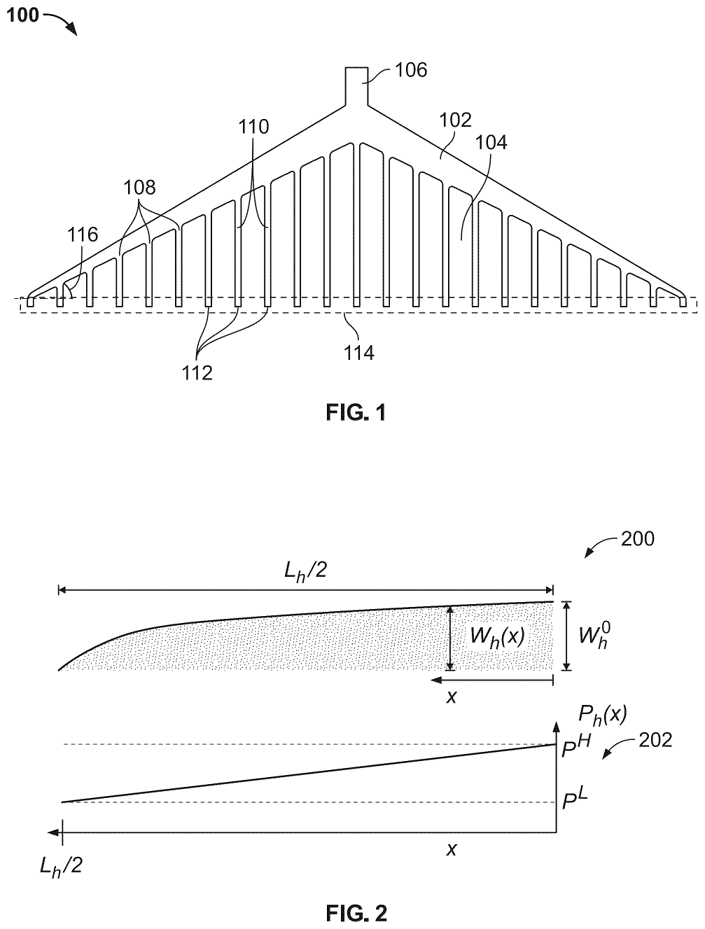

FIG. 1 is a plan view of an example manifold 100. The manifold 100 includes a header channel 102 and a triangular-shaped diffuser 104. The header channel 102 of the manifold 100 includes a port 106. The port 106 receives a fluid and provides the fluid to the header channel 102. The header channel 102 includes a plurality of openings 108 that are downstream of the port 106. The triangular-shaped diffuser 104 receives the fluid via the plurality of openings 108. Each of the openings 108 is in fluid communication with one of the plurality of channels 110 of the triangular-shaped diffuser 104. The plurality of channels 110 extend from the header channel 102 and terminate with distal openings 112 at an outlet zone 114, where the fluid exits and is distributed by the manifold 100. The outlet zone 114 is understood to be aligned along a single plane. As depicted in the plan view of FIG. 1, the plurality of channels 110 terminate at a single line, with the second dimension of the channels 110 extending in the direction into the page and therefore not depicted. In some examples, the plurality of channels 110 are equally spaced apart within triangular-shaped diffuser 104 or equidistant from a neighboring channel. The plurality of channels 110 may be parallel to each other.

The diffuser may be referred to as a triangular-shaped diffuser 104 throughout this disclosure due to an outer perimeter of the plurality of channels 110 generally forming a triangular shape. Also, the terms “header” and “header channel” are used interchangeably throughout this disclosure, as are the terms “outlet zone” and “outlet plane.” Components that are described as being in fluid communication with one another may be understood to be directly or indirectly connected such that fluid can flow in one or both directions between and/or through the components. While the manifold, components, and fluid flow may be described as inlets or outlets, proximal or distal, upstream or downstream, and the like, the manifolds may be used with fluid flows in either direction. For example, the manifold may be used as an inlet manifold, receiving a flow of fluid via the port 106 and discharging or distributing the fluid with a uniform flow from the distal openings 112 of the plurality of channels 110. The manifold may also be used as an outlet manifold, receiving a flow of fluid from the distal openings 112 of the plurality of channels 110 and discharging or distributing the fluid via the port 106. In some examples, a first manifold as described herein may be used to distribute uniform fluid flow to a device and may be paired with a second manifold to receive uniform fluid flow from the device.

To realize uniform flow among the various channels of the triangular diffuser that are in fluid communication with the header, the following design features may be applied:

Design Feature A: Linear variation of pressure along the header's length may be induced by appropriate tapering of the header's cross-section, as a function of axial position or length along the header. This feature is embodied by Eq. A, which is discussed below (see FIG. 2).

Design Feature B: The length of the diffuser channels may be varied linearly along the header to produce linear variation of intra-diffuser pressure drop along the header. This feature is embodied by Eq. B, also discussed below.

Design Feature C: The effective hydraulic resistance of the header and diffuser are preferably matched for a given header and diffuser to be compatible, such that a certain angle ϕ (see FIG. 1) is selected depending on the header and diffuser channel cross-sections. This condition assures that the pressure at the end of the header approaches that of the manifold's outlet zone. This feature is embodied by Eq. C, also discussed below.

As mentioned above, fluid flowing through the header channel 102 may experience a linear pressure variation along the length of the header channel 102. This linear pressure variation along the length of the header channel 102 may be achieved by tapering its cross-section. The cross-sectional area of the header channel 102 may be at its maximum at an upstream-most location of the header channel 102, furthest from the outlet zone 114, and may be at its minimum at a downstream-most location of the header channel 102. The cross-sectional shape of the header channel 102 may be, for example, circular, rectangular, semi-circular, obround, trapezoidal, or other suitable shape. In some examples, the width of the header channel 102 may taper along a length of the header channel 102, such as shown by the taper function 200 for one half of header channel, depicted in FIG. 2, to produce the linear pressure variation 202. Alternatively, or additionally, the height of the header channel (not depicted in FIG. 1) may taper along the length of the header channel 102. In some examples, the header channel 102 may have a circular cross-section, in which case the diameter may taper along the length of the header channel 102. The tapered header may control variations of pressure with position. Such variations may result from viscous flow in the limit of vanishing inertia, otherwise known as creeping flow or Stokes flow.

The downstream-most end of the header channel 102 may be truncated and/or tapered in a way such that it deviates from a particular tapering function. Said differently, the downstream-most end of the header channel 102 may include a smooth transition from the tapered header channel 102 to the diffuser channel 110. This may improve flow through the downstream-most channel 110. The header channel truncation may include a radiused corner, for example, a radiused corner that is tangent to both the tapered header channel 102 and the side wall of the diffuser channel 110. In some examples, the center of the downstream-most channel 110 is positioned at a distance of one-half of the spacing between each of the diffuser channels 110.

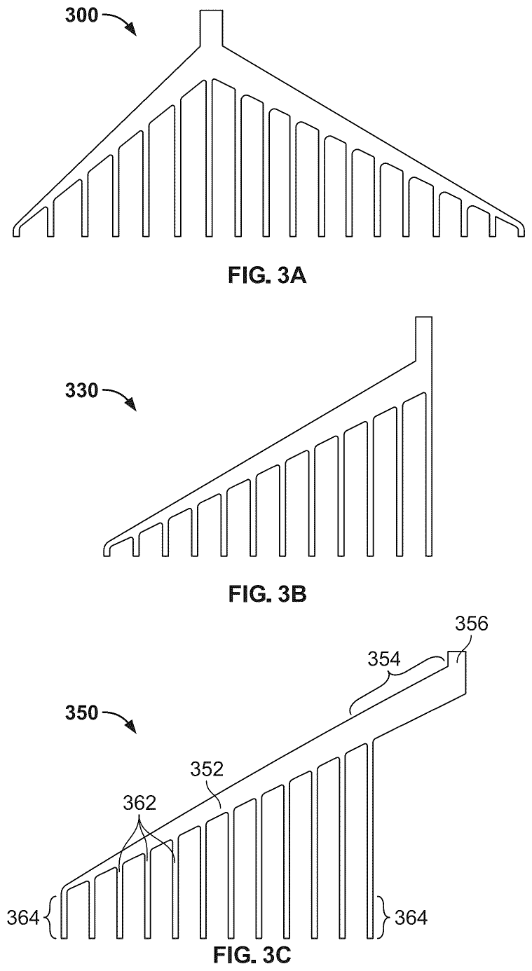

The length of the channels 110 of the diffuser 104, that is, the channel length, may vary linearly along the length of the header channel 102. Thus, for example, the length of the channel 110 nearest the upstream-most location of the header channel 102 may be longest, and the length of the channel 110 nearest the downstream-most location of the header channel 102 may be shortest. The channel length may vary in two directions along a length of the header channel 102, such as depicted in FIG. 1. In some examples, the length of the plurality of channels 110 may be symmetric about a centerline that extends between an upstream-most point of the header channel 102 further from the outlet zone 114 and a center point of the outlet zone 114, such that a perimeter of the triangular-shaped diffuser 104 forms an isosceles triangle. In another example, the longest channel of the plurality of channels 110 is not centered in the middle of the triangular diffuser and may be offset with respect to the centerline of the outlet zone 114, such that a perimeter of the triangular-shaped diffuser 104 forms a scalene triangle. Such an example manifold 300 is depicted in FIG. 3A. In yet another example, the triangular-shaped diffuser is perpendicular to the outlet zone 114 such that a perimeter of the triangular-shaped diffuser 104 forms a right triangle with the right angle of the diffuser along the outlet zone. Such an example manifold 330 is depicted in FIG. 3B.

In some examples, as depicted in FIG. 3C, the length of the header channel 352 of manifold 350 may be extended, such that it includes a header finite extent region 354 near the port 356. The header finite extent region 354 may have a generally uniform cross-section. In some examples, as depicted in FIG. 3C, the length of each of the diffuser channels 362 may be extended, such that they each include a diffuser channel finite extent region 364. The diffuser channel finite extent region 364 may have a generally uniform cross-section. The extra length provided by the finite extent region 354 of the header channel 352 and/or the finite extent region 364 of the diffuser channels 362 may compensate for entrance-region effects respectively in the header channel and the diffuser channels. The extra length may also provide a region of finite extent over which boundary layers in the respective flow paths may be allowed to develop to a fully-developed extent. While depicted in a right-triangle diffuser of FIG. 3C, such finite extent region 354 and/or finite extent region 364 may be used with other triangular-shaped diffusers, such as an isosceles-triangle-shaped diffuser, or a scalene-triangle-shaped diffuser.

The number of channels 110 on a first side of the port 106 may be the same as, or different than, the number of channels 110 on a second side of the port 106. The port 106 may be in the center of the triangular-shaped diffuser 104, may be slightly offset to one side, or may be completely offset to one side of the triangular-shaped diffuser. In some examples, the manifold 100 may include more than one port 106. The multiple ports may be equally spaced from the longest channel, or may be offset by different amounts from the longest channel. The cross-sectional shape of the channels 110 may be, for example, circular, rectangular, semi-circular, obround, trapezoidal, or other suitable shape.

In some examples, a joint between the opening 108 of the header channel and the channel 110 is radiused. The radiused joint may help with the transmission of entrained bubbles, such as when the fluid being flowed is a liquid. This may assist in ensuring uniform flow between the channels 110.

In some examples, instead of a plurality of channels 110, the triangular-shaped diffuser 104 may comprise a porous material configured to provide flow pathways through the triangular-shaped diffuser 104. In particular, the porous material may have a hydraulic permeability k_{d}. The porous material of the triangular-shaped diffuser 104 may be homogenous such that its hydraulic permeability is predictable. The porous material may have a regular microstructure. For example, the porous material may be an array of solid parallel cylinders whose axes are oriented in the out-of-plane direction and positioned in a square lattice. Alternatively, the porous material may have an irregular microstructure. For example, the porous material may be formed by sintering a packing of solid particles. The diffuser hydraulic permeability k_{d} may be determined by measuring it for a representative sample of the porous material or, if the porous material has a regular structure, it could be predicted using a physics-based model of flow through a unit-cell of the porous material. The same design features may apply to the triangular-shaped diffuser 104 when it comprises a porous material—e.g., it may have triangular shape (design feature B) and a compatible angle (design feature C). A difference, however, is that feature C may be applied using a more general formula for the compatible angle, where it is posed in terms of diffuser hydraulic permeability k_{d}, diffuser-region height h_{d}, and manifold width Lₘ, rather than determining it in terms of the number of diffuser channels N_{d} and diffuser-channel conductance G_{d}, as shown in the following section.

A perimeter of the triangular-shaped diffuser at a downstream-most location of the header channel adjacent to the outlet zone may form an angle ϕ 116 of the triangular-shaped diffuser. Stated differently, a downstream-most location of the header channel may intersect the outlet plane at an angle ϕ 116. The angle ϕ may depend on k_{d} and Gₕ⁰, as described in the modeling section below.

Advantageously, the manifold 100 may provide a uniform flow velocity of a fluid at the outlet zone 114 during fluid flow. Uniform flow velocity may generally refer to the velocity at the outlet zone 114 of each of the plurality of channels 110 being approximately the same, or within a maximum deviation of 10% of each other.

The manifold 100 may be effectively used with fluid flows having a Reynolds numbers of approximately 10 or less. In some examples where the channels 110 possess a length that is much greater than their hydraulic diameter and because the laminar hydrodynamic entrance length x_{fd} is approximately equal to the diffuser-channel hydraulic radius for a Reynolds number of 10, the channels 110 exhibit fully developed flow over most of their length.

In some examples where the Reynolds number of the fluid is greater than 10, entrance-region effects may emerge in the header channel 110. This may cause fluid flow to be biased into a channel 110 nearest the port 106 while starving other channels 110 further away from the port 106. To mitigate such effects, in some examples, the channels 110 may be located such that there are no channels 110 directly below the port 106. In some examples, an even number of channels 110 may be used, such that the number of channels 110 on either side of the port 106 are equal. To uniformize laminar, turbulent, or transitional flow at finite Reynolds number, the manifold 100 could provide a starting point for manifold optimization by using perturbations to the header tapering function or by using a diffuser permeability that is functionally graded along the transverse coordinate.

The velocity distribution of the manifold 100 described herein may be uniform for Reynolds numbers of approximately 10 or less. This may provide for a wide operating range of flow rate based on Reynolds number as a result of employing a tapered header and triangular-shaped diffuser. The manifold 100 may also possess overall hydraulic resistance that is equivalent to that of a rectangular diffuser fed by an isobaric header, which makes the disclosed manifold more hydraulically efficient than other manifold designs using the same central diffuser-channel length and the same central header cross-section.

The manifold 100 may also be used with non-Newtonian fluids (e.g., shear-thinning or shear-thickening fluids) by determining the appropriate values of conductance for the header channel 102 and the channels 110 in Poiseuille flow of the corresponding non-Newtonian fluid. These manifold design principles are also extendible to flows of rarified gases, free-molecular (i.e., Knudsen) flows, and flows having a finite degree of slip velocity at walls.

While the disclosed manifold 100 has been described above predominantly for use as an inlet manifold, the manifold 100 may also be used as an outlet manifold. In such examples, the outlet zone 114 may be an inlet zone, and the plurality of openings 108 of the header channel 102 may be upstream of the port 106. The fluid may travel from the inlet zone through the channels 110 to the header channel 102. After passing through the header channel 102, the fluid may pass through port 106. The other characteristics of the manifold 100 may be consistent with those embodiments described previously herein. In some examples, the manifold 100 may be used as an isolated, i.e., unpaired, inlet manifold or as an isolated outlet manifold. In other examples, the manifold 100 may be used as both an inlet and outlet manifold in a paired configuration.

In some examples, two tiers of manifolds 100, which may or may not have similar designs, may be arranged as an array of inlet manifolds. That is, the distal openings 112 of the first-tier manifold may be connected to respective ports 106 of an array of second-tier manifolds 100. The number of diffuser channels 110 of the first-tier manifold may match the number of second-tier manifolds. Thus, there may be a rectangular array of N_{d,1}-by-N_{a,2} diffuser channels at the outlet plane of the second tier of manifolds, where N_{d,1} and N_{d,2} are the number of diffuser channels respectively used in each first-and second-tier manifold. Such an arrangement may deliver fluid uniformly to an outlet plane that is shaped as a two-dimensional rectangle. Such a tiered set of inlet manifolds may also be used in conjunction with a similar tiered set of outlet manifolds in a paired configuration. The tiered set of manifolds may also be used by themselves as an array of outlet manifolds.

In some examples, a plurality of manifolds may be used in conjunction with each other to divide the fluid an arbitrary number of times. The plurality of manifolds may have an aligned orientation, or their orientations may be at some angle to each other.

The manifold 100 described herein according to various embodiments may provide several advantages over other manifold designs. The manifold 100 may provide a low deviation from uniformity of diffuser-velocity distribution, compared to, for example, a straight rectangular header with rectangular diffuser, or a straight triangular header with a triangular-shaped diffuser. The manifold 100 may provide uniform flow without use of baffles, valves or electronics, which can add significant size and bulk to a device and are difficult to incorporate into stacks of devices. The manifold 100 may provide a smaller footprint, reducing bulk. For example, the footprint of the manifold 100 may be half of the footprint for a straight rectangular header with rectangular diffuser manifold. The manifold 100 may also provide a smaller footprint over traditional bifurcating manifolds. In addition, because the manifold 100 uses a triangular-shaped diffuser 104 comprised of channels 110 with linearly varying lengths, flow may be promoted to the shortest diffuser channels nearest the end of the header channel 102.

The manifolds described herein may be used to provide uniform flow velocity of a fluid useful for a variety of applications. For example, the manifolds may be used with a catalyst. A reactant fluid may be flowed through the manifold such that the manifold provides uniform flow of the reactant across the catalyst. The manifolds may be used as part of a hydraulic or pneumatic actuation device. The manifolds may be used in a chromatography system to provide uniform flow and distribution of analyte fluids. The manifolds may be used as part of a heat exchanger to provide uniform flow and distribution of a cooling fluid. This may help minimize hot spots in the heat exchanger. The manifolds may be used as part of a desalination or electroseparation system. The manifolds may also be used as part of a liquid coating apparatus or a liquid spraying apparatus to create coatings from liquid solutions or suspensions where a continuous film is sought. In other examples, the manifolds may be used as part of a flow battery, a fuel cell, a microfluidic device, or an electrolyzer to provide uniform flow of a fluid.

### Modeling

A quasi-one-dimensional (quasi-1D) formulation for manifold 100 may be used to analyze the coupling of header pressure pₕ along the length of the header channel 102, described by coordinate x to the diffuser's superficial velocity component u_{s,⊥} normal to the header channel's length. This quasi-1D model may hold provided that transverse pressure variations within the header channel 102 are negligible. Quasi-1D analysis produces the following ordinary differential equation for pₕ(x):

$$\frac{d}{d x} [ \frac{- {G}_{h}}{μ} \frac{{dp}_{h}}{dx} ] = - {u}_{s , ⊥} {h}_{d}$$

Here, Gₕ is the local hydraulic conductance defined as Gₕ≡−\dot{V}_{∥}μ/(dpₕ/dx) in terms of volumetric flow rate along the header \dot{V}_{∥}, dynamic viscosity u, and header pressure ph. In practice, Gₕ may be approximated by using its value determined from fully developed, laminar Poisuelle flow through a channel having an invariant cross-section. The product of superficial velocity and diffuser-region depth u_{s,⊥}h_{d} is constant based on uniform fluid exchange between the header channel 102 and the triangular-shaped diffuser 104, so as to yield the following equation after integration:

$$\frac{- {G}_{h}}{μ} \frac{d {p}_{h}}{d x} = - {u}_{s , ⊥} {h}_{d} x + κ$$

Since the volumetric flow rate \dot{V}_{∥} vanishes at the downstream-most portion of the header channel 102 (x=Lₕ/2, where Lₕ is the total length of the header channel), the integration constant κ is u_{s,⊥}h_{d}(Lₕ/2). As a result, the following relation for the gradient of header channel pressure is produced:

$$\frac{d {p}_{h}}{d x} = \frac{- {u}_{s , ⊥} {h}_{d} ( {L}_{h} / 2 - x ) μ}{{G}_{h}}$$

Based on a chosen linear variation of the pressure along the length of the header channel 102 (for example, the pressure variation 202 of FIG. 2) the entrance pressure of the header p^{H} and pressure at the outlet zone 114 of the triangular-shaped diffuser 104 p^{L} can be used to express the axial pressure gradient of the header channel 102 that is invariant with position x: dpₕ/dx=(p^{L}−p^{H})/(Lₕ/2). By equating this result with that produced by quasi-1D analysis and by using algebraic operations to simplify, we obtain the following design equation for local hydraulic conductance in the header channel 102:

$${G}_{h} ( x ) = \frac{{u}_{s , ⊥} {h}_{d} {μ ( {L}_{h} / 2 )}^{2} ( 1 - x / ( {L}_{h} / 2 ) )}{{p}^{H} - {p}^{L}}$$

By using the required local hydraulic conductance at the upstream-most location of the header channel (Gₕ⁰=Gₕ(x=0)=−u_{s,y}h_{d}μ(Lₕ/2)²/(p^{H}−p^{L})), the required conductance variation with dimensionless position x*=x/(Lₕ/2) may be normalized as follows:

$$\frac{{G}_{h}}{{G}_{h}^{0}} = 1 - \frac{x}{\frac{{L}_{h}}{2}} = 1 - {x}^{*} \qquad ( Eq . A )$$

The pressure of the fluid may vary linearly along the length of the header channel 102 when the hydraulic conductance decreases linearly with dimensionless position, as detailed by Eq. A. This local hydraulic conductance may be used to determine a tapering of a cross-section of the header channel 102 along its length, shown by the taper function 200 of FIG. 2.

The linear pressure variation along the length of the header channel 102 may also include the effect of pressure variations arising from viscous friction and from specific kinetic energy (i.e., kinetic energy per unit fluid mass) variations subject to energy conservation, as a result of local acceleration or deceleration of the mean flow.

In analyzing the manifold 100, for examples of circular or rectangular channel 110, the mathematical solution for fully developed Poiseuille flow through may be used. The diameter dₕ of an example header channel 102 with a circular cross-section without slip is shown to follow a quartic-root profile due to the local quartic law (LQL) variation of its hydraulic conductance with diameter (Gₕ=πdₕ⁴/(128μ)):

$$\frac{{d}_{h}}{{( {d}_{h} )}^{0}} = {( 1 - {x}^{*} )}^{1 / 4}$$

For an example header channel 102 in which the cross-section is rectangular, in the limit of small header width wₕ relative to its depth hₕ, a local cubic law (LCL) may be used in the width (Gₕ=wₕ³hₕ/12Click or tap here to enter text.) to determine the width variation when depth is fixed may follow a cubic-root variation with position along the length of the header channel:

$$\frac{{w}_{h}}{{( {w}_{h} )}^{0}} = {( 1 - {x}^{*} )}^{1 / 3}$$

Various example taper functions for the header channel 102 are enumerated in Table I, below. By employing such example tapered header channel 102 designs, a uniform pressure gradient subject to uniform flow away from the header may be achieved.

TABLE I
Taper functions for headers used to achieve uniform flow where x* = 2x/Lₕ.

| Cross-Section | Limits | Constraints | Taper Function |
|---|---|---|---|
| Rectangular | wₕ << hₕ | hₕ fixed | wₕ = wₕ⁰\|1 − x*\|^{1/3} |
| Rectangular | wₕ >> hₕ | hₕ fixed | wₕ = wₕ⁰\|1 − x*\| |
| Rectangular | wₕ << hₕ | wₕ fixed | hₕ = hₕ⁰\|1 − x*\| |
| Rectangular | wₕ >> hₕ | wₕ fixed | hₕ = hₕ⁰\|1 − x*\|^{1/3} |
| Rectangular | None | hₕ fixed | $\frac{{G}_{h} / {h}_{h}}{{G}_{h}^{0} / {h}_{h}} = \vert 1 - {x}^{*} \vert$ |
| Rectangular | None | wₕ fixed | $\frac{{G}_{h} / {w}_{h}}{{G}_{h}^{0} / {w}_{h}} = \vert 1 - {x}^{*} \vert$ |
| Rectangular | None | hₕ(x)~wₕ(x)^{a} | wₕ = wₕ⁰\|1 − x*\|^{1/4} |
| | | | hₕ = hₕ⁰\|1 − x*\|^{1/4} |
| Circular | None | None | dₕ = dₕ⁰\|1 − x*\|^{1/4} |
| Others^{b} | None | Isotropic scaling | lₕ = lₕ⁰\|1 − x*\|^{1/4} |
| | | of cross-section | |

ªThis constraint listed here for Rectangular cross-section scales the cross-section's width in identical proportion to its depth.
^{b}The taper function listed here for Others cross-section applies to all dimensions of the cross-section of interest when that cross-section is scaled isotropically.

In some examples, mean velocity variation along the header channel 102 within the header channel is nullified by choosing a mode of header channel cross-section variation wherein the cross-sectional dimension being varied is much larger than the cross-sectional dimension being fixed. The net result of such a design condition is to make the mean specific kinetic energy of the fluid constant along the length of the header channel, thus nullifying its effect on pressure gradients. For example, such a condition can be achieved by tapering the width of header channel while using a fixed depth of the header channel, for example, when the header channel width is much greater than header depth.

In some examples, the geometry of the header channel 102 is chosen to make mean velocity invariant along the header channel such that fluid parcels transiting through each channel 110 take the same time to reach the distal openings 112. Achieving a mono-modal residence time distribution may be useful where the fluid contains transient concentration or temperature gradients, such that by having a mono-modal residence time distribution fluid of a given concentration or temperature will synchronously be affected by whatever transient processes the fluid is being subjected to.

The triangular-shaped diffuser 104 of the manifold 100 may be modeled as a continuum of fluid-permeable material that exchanges fluid with its abutting header. Accordingly, Darcy's law may be used to describe the relationship between superficial velocity u_{s,y} in the y direction and pressure as: u_{s,y}=−(k_{d}/μ)∂p/∂y. The anisotropic property of the triangular-shaped diffuser enables expression of ∂p/∂y at a particular x location directly in terms of local header channel pressure pₕ(x) and pressure at the exit plane of the header channel p^{L}:

$${u}_{s , y} = \frac{- {k}_{d}}{μ} \frac{( {p}^{L} - {p}_{h} ( x ) )}{{L}_{d} ( x )}$$

Here, diffuser length L_{d}(x) is allowed to vary with position x along the header channel 102. By using the associated variation of pₕ(x) from before (pₕ(x)=p^{H}−x(p^{H}−p^{L})/(Lₕ/2)), the diffuser length L_{d}(x) needed to induce uniform u_{s,y} may vary linearly with position x along the header channel 102:

$${L}_{d} ( {x}^{*} ) = \frac{{k}_{d}}{μ {u}_{s y}} ( {p}^{H} - {p}^{L} ) ( 1 - {x}^{*} )$$

By using the diffuser length at the upstream-most location of the header channel 102 (L_{d}⁰=L_{d}(x=0)=k_{d}(p^{H}−p^{L})/μu_{s,y}), the diffuser-length variation may be normalized with dimensionless position x*=x/(Lₕ/2) as follows:

$$\frac{{L}_{d}}{{L}_{d}^{0}} = 1 - {x}^{*} \qquad ( Eq . B )$$

Eq. B shows that the diffuser of the manifold may use a triangular shape to produce linear variation of intra-diffuser pressure drop.

The manifold may be modeled by using a porous diffuser region comprised of equally spaced channels aligned along the y direction, such that diffuser permeability may be related to channel dimensions by analysis of flow on a repeat unit associated with a single diffuser channel. The apparent hydraulic permeability k_{d} of the diffuser region k_{d}=G_{d}/A_{d} may depend on the superficial flow-normal area of the repeat unit associated with a single channel 110 described by A_{d} and the hydraulic conductance of a single channel 110 described by G_{d}≡−\dot{V}_{d}μ/(dp_{d}/dy). Here, \dot{V}_{d} is the volumetric flow rate through a single channel 110 and p_{d} is the local pressure within the same channel. G_{d} depends on the shape of the cross-section of the channel 110 that can take various forms as described previously.

A compatibility condition between a header channel 102 and a triangular-shaped diffuser 104 may be used to provide uniform flow at the outlet zone 114 of the manifold 100. Uniform flow at the outlet plane can be achieved when pressure at the end of the header p(x=Lₕ/2) approaches p^{L}. This may be achieved by matching the resulting hydraulic resistance predicted based on separate analyses of flow through the header channel 102 and the triangular-shaped diffuser 104. Hydraulic resistance Rₕ may be defined as the ratio of the total driving pressure across the manifold p^{H}−p^{L} to the total volumetric flow rate \dot{V}ₜₒₜ produced through it. Based on the flow through the header channel, the total flow rate is \dot{V}ₜₒₜ=2\dot{V}_{∥}(x=0)=4Gₕ⁰(p^{H}−p^{L})/(Lₕμ). Thus, the hydraulic resistance may be provided by:

$${R}_{h , h} = \frac{μ {L}_{h}}{4 {G}_{h}^{0}}$$

Based on the flow through the triangular-shaped diffuser, the total flow rate may be provided by \dot{V}ₜₒₜ=−u_{s,y}h_{d}Lₘ=k_{d}(p^{H}−p^{L})h_{d}Lₘ/(L_{d}⁰μ), where Lₘ is the manifold's width. Thus, the hydraulic resistance based on diffuser analysis is:

$${R}_{h , d} = \frac{μ {L}_{d}^{0}}{{k}_{d} {L}_{m} {h}_{d}}$$

An α=R_{h,h}/R_{h,d}=1 may provide that the header channel 102 and diffuser 104 are compatible, where α is expressed as:

$$α = \frac{{L}_{h} {L}_{m} {h}_{d} {k}_{d}}{4 {L}_{d}^{0} {G}_{h}^{0}} = 1$$

The length Lₕ of the header channel 102 and length L_{d}⁰ of the longest channel 110 may depend on the angle of the manifold (ϕ) for a certain manifold width Lₘ:Lₕ=Lₘ/cos ϕ and L_{d}⁰=Lₘ tan ϕ/2. Accordingly, a may be expressed in terms of ϕ and Lₘ alone:

$$α = \frac{{k}_{d} {L}_{m} {h}_{d}}{2 sin ϕ {G}_{h}^{0}} = 1$$

A diffuser angle ϕ that may provide compatibility between the header and diffuser may depend on width Lₘ of the triangular-shaped diffuser 104 at the outlet zone, a hydraulic conductance at a center Gₕ⁰ of the header channel 102, diffuser hydraulic permeability k_{d}, and diffuser depth h_{d}:

$$ϕ = {sin}^{- 1} ( \frac{{k}_{d} {L}_{m} {h}_{d}}{2 {G}_{h}^{0}} )$$

In some examples, where the triangular-shaped diffuser 104 is comprised of a porous material, the diffuser hydraulic permeability k_{d}, may be determined by measuring it for a representative sample of diffuser-channel material or it could be predicted using a physics-based model of flow through a unit-cell of the porous material if it has a regular structure.

In some examples, where channels 110 of the triangular-shaped diffuser 104 equally spaced and parallel channels 110, the number of diffuser channels N_{d} may be expressed by the quotient of manifold width Lₘ and the spacing s_{d} between diffuser channels. The diffuser angle ϕ to produce a compatible header and diffuser may be expressed by:

$$ϕ = {sin}^{- 1} ( \frac{{k}_{d} {L}_{m} {h}_{d}}{2 {G}_{h}^{0}} ) = {sin}^{- 1} ( \frac{{N}_{d} {G}_{d}}{2 {G}_{h}^{0}} ) \qquad ( Eq . C )$$

The associated length of channels at the header's center is then determined as L_{d}⁰=(Lₘ/2) tan ϕ, and the associated header length is determined as Lₕ=Lₘ/cos ϕ.

This angle ϕ may vary depending on the geometry of the header channel 102 and the channels 110. Table II summarizes some example combinations where the same type of cross-sectional geometry is used for both the header channel 102 and the channels 110. While Table II only provides detail on rectangular and circular cross-sectional geometries, others are also conceivable and within the scope of the present disclosure. For example, a semi-circular, obround, or trapezoidal, cross-section may be used.

TABLE II
Compatibility criteria for a certain cross-section type of both the header
102 and diffuser 104.

| Cross-Section | Limits | Constraints | Compatibility Criterion |
|---|---|---|---|
| Any | None | None | $ϕ = {sin}^{- 1} ( \frac{{N}_{d} {G}_{d}}{2 {G}_{h}^{0}} )$ |
| Rectangular | wₕ << hₕ w_{d} << h_{d} | hₕ⁰ = h_{d} | $ϕ = {sin}^{- 1} ( \frac{{N}_{d}}{2} {( \frac{{w}_{d}}{{w}_{h}^{0}} )}^{3} )$ |
| Rectangular | wₕ >> hₕ w_{d} >> h_{d} | hₕ⁰ = h_{d} | $ϕ = {sin}^{- 1} ( \frac{{N}_{d}}{2} \frac{{w}_{d}}{{w}_{h}^{0}} )$ |
| Circular | None | None | $ϕ = {sin}^{- 1} ( \frac{{N}_{d}}{2} {( \frac{{d}_{d}}{{d}_{h}^{0}} )}^{4} )$ |

In addition to providing various example combinations of dimensions for prescribed header/diffuser design parameters, the above equation reveals that certain header/diffuser designs are not feasible for uniformizing flow. In particular, feasible designs require the following inequality to be satisfied since ϕ>π/2 is a geometrically impossible infeasible condition:

$$β = \frac{{N}_{d} {G}_{d}}{2 {G}_{h}^{0}} < 1$$

Smaller values of β and ϕ may be desirable to provide a more compact manifold 100. Other cross-section types and dimensions, beyond those described in Table II may be used.

### EXAMPLES

The theory presented in this disclosure has been implemented to design, fabricate, and test a uniformizing manifold. As discussed above, to realize uniform flow among the various channels of the triangular diffuser that are in fluid communication with the header, the following design features may be applied:
(A) Linear variation of pressure along the header's length may be induced by appropriate tapering of the header's cross-section, as a function of axial position or length along the header. This feature is embodied by Eq. A above.
(B) The length of the diffuser channels may be varied linearly along the header to produce linear variation of intra-diffuser pressure drop along the header. This feature is embodied by Eq. B, also discussed above.
(C) The effective hydraulic resistance of the header and diffuser are preferably matched for a given header and diffuser to be compatible, such that a certain angle ϕ is selected depending on the header and diffuser channel cross-sections. This condition may ensure that the pressure at the end of the header approaches that of the manifold's outlet zone. This feature is embodied by Eq. C, also discussed above.

### Methods

In this example, the manifold has a tapered header channel with a 0.75 mm deep rectangular cross-section in combination with a triangular diffuser region containing an array of 23 parallel channels regularly spaced at 1.96 mm that have square cross-section with 0.50 mm depth and 0.50 mm width. In addition, a central header width equal to wₕ⁰=2.2 mm is selected while using a 45 mm manifold width. With those parameters chosen, the compatibility condition (Eq. C above) is used to determine the diffuser angle ϕ=24.0° based on central header conductance Gₕ⁰ and diffuser-channel conductance G_{d}, both of which were calculated using Boussinesq's series solution for fully developed Poiseuille flow through an h-by-w rectangular duct:

$$G = \frac{{h}^{2}}{12} - \frac{16 {h}^{3}}{w {π}^{5}} {\sum }_{n = 1}^{∞} \frac{coth ( ( 2 n - 1 ) w / h ) - csch ( ( 2 n - 1 ) w / h )}{{( 2 n - 1 )}^{5}}$$

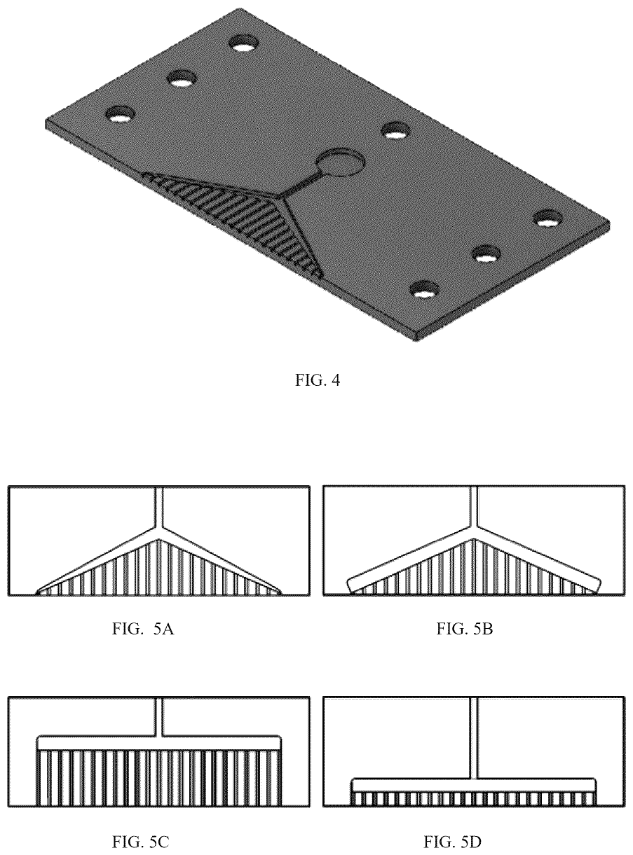

Using the manifold width of interest (45 mm), this angle produced a central diffuser length L_{d}⁰=10.0 mm and a total header length Lₕ=49.2 mm. The length of all other diffuser channels was chosen to produce a triangular diffuser (Eq. B above). Finally, Gₕ values were then sampled using Boussinesq's solution with a set of header widths {wₕ} ranging between zero and its central value of 2.2 mm to determine the position x to be associated with a certain header width Wh, thus enforcing Feature A (Eq. A): x=Lₕ(1−Gₕ(wₕ)/Gₕ⁰)/2. The resulting design of the tapered-header, triangular-diffuser manifold (TH-TD) is shown in FIG. 4, along with a summary of dimensions in Table III below.

TABLE III
Exemplary Uniformizing Manifold Dimensions

| Dimension | Symbol | Value | |
|---|---|---|---|
| Central diffuser length | L_{d}⁰ | 10 | mm |
| Header depth | hₕ | 0.75 | mm |
| Channel depth (diffuser) | h_{d} | 0.5 | mm |
| Channel width (diffuser) | w_{d} | 0.5 | mm |
| Channel spacing (diffuser) | s_{d} | 2 | mm |
| Central header width | wₕ⁰ | 2.2 | mm |
| Total header length | Lₕ | 49.2 | mm |
| Manifold width | Lₘ | 45 | mm |

In addition, three other manifolds which do not include one, two, or all three of the design features were examined and compared to the TH-TD manifold (FIG. 5A) in terms of flow uniformity at the exit plane. These include a straight-header, triangular-diffuser (SH-TD) manifold (FIG. 5B), which does not include design feature A, a straight-header, rectangular-diffuser (SH-RD) manifold (FIG. 5C), which only includes design feature C, and a SH-RD manifold that does not include any of the design features (FIG. 5D). Each such manifold had a header region with a depth of 0.75 mm and 23 parallel diffuser channels spaced 1.96 mm apart, each having a rectangular cross-section with 0.50 mm width and 0.50 mm depth. SH-TD and SH-RD manifolds were created with center-channel lengths of 10 mm. In addition, a SH-RD manifold was created with a center-channel length of 2.5 mm.

These manifolds were designed and their tool-path was generated (AutoCAD Fusion 360) as G-code to mill each manifold into clear polymethyl methacrylate (PMMA) plastic. Milling was performed at a spindle speed of 18,000 rev min⁻¹ using a micro end-mill (Harvey Tools) with a diameter of about 0.40 mm and length of cut of about 1.19 mm. A desktop computer numerical control (CNC) machine using precision ball screws advanced by closed-loop stepper motors with GRBL Mega v.1.1 motion control firmware rastered the micro end-mill through PMMA. The dimensions of machined diffuser-channel cross-sections were found to be within 20 μm of the intended design.

All manifolds were incorporated into a flow cell for flow visualization. Here, two additional 9-mm-thick PMMA plates were laser cut (Trotec Speedy Flexx 400) to support the manifold on its opposing sides, and a 0.38 mm polytetrafluoroethylene (PTFE) sheet (McMaster-Carr) was used as a gasket. Before each test, the flow cell was submerged in water within a 15cm PMMA tank shaped as a cube. To visualize flow through cach manifold, dye solution was prepared by mixing 5 mL of yellow food coloring with 1 L of water containing 0.5% sodium dodecylbenzene sulfonate (SDBS; Sigma Aldrich) surfactant. Before conducting flow visualization of any given manifold, the flow cell was primed with water containing 0.5% SDBS to remove bubbles from the manifold. All solutions were pumped into each flow cell using syringe pumps (New Era InfusionONE), with one pump delivering dyed solution and the other delivering undyed solution. The manifolds were tested for different flow rates varying from 1mL min⁻¹ to 5 mL min⁻¹, which corresponds to a Reynolds number range of 1.63 to 8.13. Here, the Reynolds number is given by Re=u_{avg}w_{d}ρ/μ with diffuser-channel width w_{d}, mean diffuser-channel velocity among all diffuser channels u_{avg}, density ρ, and dynamic viscosity μ. A Nikon D5300 DSLR camera was employed to record the motion of dyed jets that effused from diffuser channels with a frame rate of 50 frames/s. LED illumination (Neewer) above the camera was also used to enhance imaging sensitivity. Velocities were measured at the exit plane of a given manifold within the tank into which jets were flowed. This location was chosen from which to sample velocities to isolate the flow distribution produced by a given manifold from downstream effects within the tank into which they were flowed.

The velocity of dye jets issued from each diffuser channel was calculated as the slope of vertical position of the dye front versus time, as determined by linear regression. The vertical position of each dye front, corresponding to each diffuser channel, was determined for a given frame using the following approach: (1) a given frame was first segmented into 23 equally sized regions, cach containing one diffuser channel; (2) then each such segmented red-green-blue (RGB) image was divided into regions of low blue intensity corresponding to dyed solution and high blue intensity corresponding to undyed solution, since the yellow dye used here is a combination of red and green alone; and (3) the lowest vertical coordinate associated with the dyed region of solution was determined as the dye front for each segment.

Numerical simulations of steady-state, laminar flow were performed using OpenFOAM to predict velocity and pressure fields produced by the uniformizing, TH-TD manifold and other manifolds. All simulations were done using the incompressible, steady Navier-Stokes equations together with the continuity equation:

$$ρ ( u \cdot ∇ u ) = - ∇ p + μ {∇}^{2} u$$

$$∇ \cdot u = 0$$

Here, u is the local fluid velocity, ρ is the density of the fluid, p is its pressure, and μ is its dynamic viscosity. In all simulations, a uniform-pressure boundary condition was employed at a given manifold's inlet port (pᵢₙ) and across its exit plane (pₒᵤₜ=0). The resulting Reynolds number was determined based on the flow rate produced by a certain pressure difference between the inlet port and the exit plane. All cases used meshes containing ˜10⁶ finite-volume cells. Additionally, iterative convergence was achieved for all simulations to relative residuals for pressure, velocity, and continuity of 10⁻⁴%.

### Results

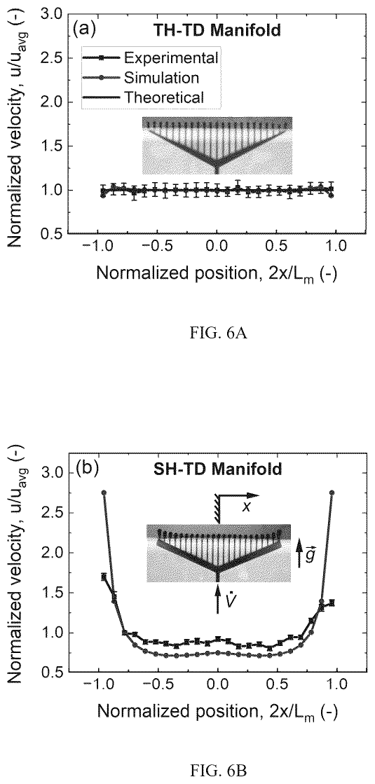

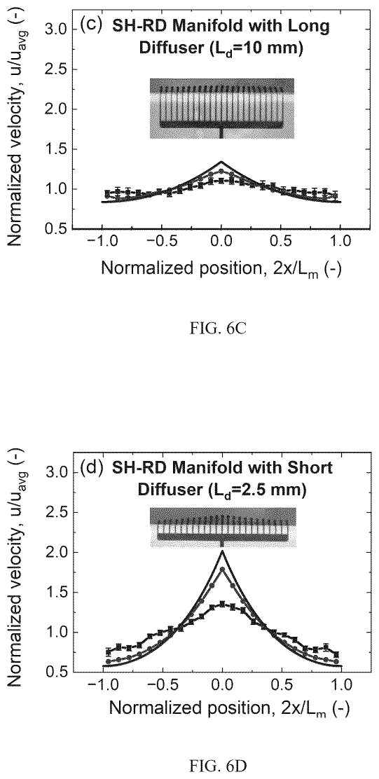

Flow visualization experiments were performed on the tapered-header, triangular-diffuser (TH-TD) manifold and two other manifold types to investigate the effects of the header and diffuser design features described above on the resulting flow distribution produced when flowing into an open tank. Results obtained for the lowest total flow rate tested (1 mL min⁻¹) to produce flow wherein inertia is insignificant are discussed first. While the associated diffuser-channel Reynolds number (Re≈1.6) is technically larger than the conventional cutoff for creeping flow (Re<1), the experimental and simulated results of the TH-TD manifold (FIG. 6A) and two different SH-RD manifolds (FIGS. 6C and 6D) match those of the present theory. Accordingly, FIG. 6A shows that the experimental diffuser-velocity distribution of the TH-TD manifold exhibits the least deviation from uniformity (3% max.) among all manifolds tested. While the SH-RD manifold with a long diffuser (L_{d}=10 mm) also produces small deviation from uniformity (10% max.), it is observed that the footprint of the long-diffuser SH-RD manifold is two-fold that of the TH-TD. In addition, analysis of Fourier-transformed velocity (sec ESM) reveals that the SH-RD possesses a co-sinusoidal velocity-deviation “mode” that spans the entire extent of the manifold, demonstrating that a lack of header tapering (design feature A) and diffuser-region triangulation (design feature B) results in systemic deviation from flow uniformity. Here, flow is respectively promoted and suppressed at the SH-RD manifold's center and ends. In contrast, Fourier analysis shows that the TH-TD manifold produces relatively localized deviations from uniformity in comparison with the SH-RD manifold that result from inaccuracy in manifold fabrication (˜20 μm) and secondary-flow effects under the conditions tested. Thus, the long-diffuser version of the SH-RD manifold is shown to produce modest deviation from uniformity only because its diffuser-channel length was chosen to satisfy design feature C, despite this SH-RD manifold's exclusion of features A and B. In addition, FIG. 6D shows that when design feature C is further relaxed in designing a SH-RD manifold by decreasing diffuser length four-fold (L_{d}=2.5 mm), its deviation from flow uniformity grows two-fold (35% max.) as a result of excluding all three design features. Experiments using an SH-TD manifold also confirm the importance of header tapering (design feature A) in conjunction with the other two design constraints. As shown in FIG. 6B, the associated diffuser-velocity distribution exhibits more than 50% greater velocity at the ends of the manifold than at its center when omitting feature A. The promotion of flow to the ends of the SH-TD manifold is caused by insignificant header hydraulic resistance relative to the TH-TD manifold. Consequently, the hydraulic resistance of individual diffuser channels within the SH-TD manifold acts as a bottleneck for flow to each diffuser channel. Thus, because the TH-TD manifold uses a diffuser region comprised of channels with various lengths, flow is promoted to the shortest diffuser channels. This effect therefore underscores the importance of using an appropriately tapered header (design feature A) in conjunction with a triangular diffuser region (design feature B) and a compatible angle (design feature C).

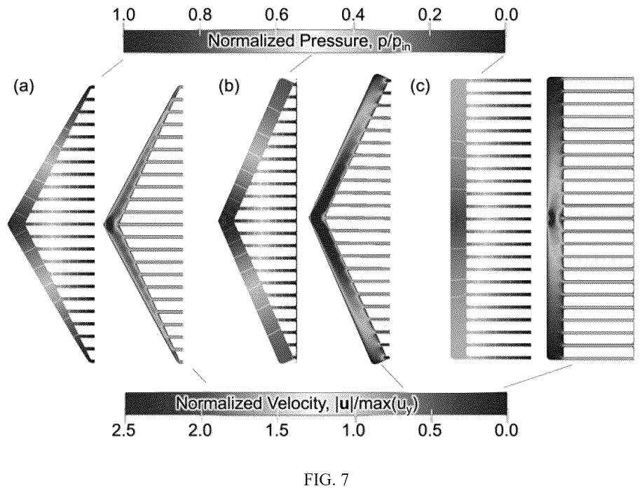

Consistency between the velocity distributions produced in experiments with those of simulations provides insight into the mechanisms that produce their functionality. Accordingly, FIG. 7 shows the simulated pressure and velocity fields produced in the creeping-flow limit (Re≈0.1) for the TH-TD, SH-TD, and SH-RD manifolds using L_{d}=10 mm. The header regions of both the uniformizing, TH-TD manifold and the SH-TD manifold show substantial variation of pressure along the header, with the TH-TD manifold having a larger gradient among the two manifolds. Notably, the pressure contours in the header produced by the TH-TD manifold are shown to be equally spaced, consistent with design Constraint A that requires a constant pressure gradient in the header. In contrast, the SH-RD manifold shows comparatively uniform header pressure due to the lack of header tapering that would act to increase pressure gradients. Also, transverse pressure gradients in the TH-TD manifold were negligible, while the SH-TD manifold shows mild transverse header-pressure variations and the SH-RD manifold shows stronger transverse variations. The diffuser regions of the TH-TD manifold shows a linear and uniform variation of pressure across all channels as a result of the relatively uniform flow occurring among its diffuser channels. The SH-RD manifold shows a linear, less uniform variation of pressure along diffuser channels. Most importantly, the velocity field of the TH-TD manifold shows uniform flow to each diffuser channel except for the end diffuser channels that are within 10% of the flow rate of the others. In contrast, the SH-TD manifold shows velocities which are larger in the edge channels of the diffuser compared to the center, consistent with experiments. The SH-RD manifold shows larger velocities in the center channels relative to the edges, also consistent with experiments.

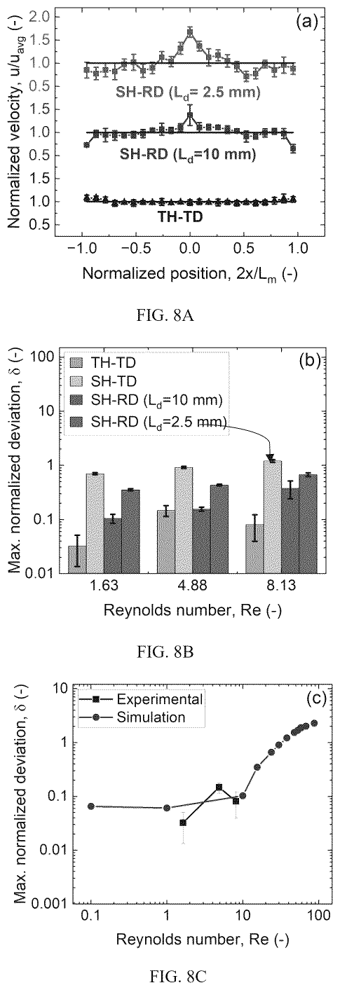

The highly uniform flows produced by the TH-TD manifold at modest diffuser-channel Reynolds number (Re˜1) motivate understanding the impact of increased inertia on its performance, given that the theory used to design it assumes creeping flow. FIG. 8A shows that the velocity distribution of the TH-TD manifold remains uniform at Re˜10, despite long-and short-header versions of the SH-RD manifold exhibiting the promotion of velocity in the centermost channels. These effects translate to the TH-TD manifold producing least velocity deviation among all manifolds tested for Re as high as 10 (FIG. 8B). Higher Reynolds number than 10 was not tested due to the onset of transient flow within the downstream region of the jets produced by liquid effusion from a given manifold. However, we conducted complementary simulations at diffuser-channel Reynolds numbers up to ˜100 for the TH-TD manifold. FIG. 8C shows that the maximum velocity deviation increases rapidly with increasing Re for Re>10, thus predicting the upper bound for the range of Re over which the TH-TD manifold produces uniform flow. The mechanisms that are responsible for these effects are elucidated by examining local velocity and pressure fields, after first reconciling them based on entrance lengths expected from Poiseuille flow.

The predicted departure from flow uniformity that occurs for the TH-TD manifold at a diffuser-channel Reynolds number of ˜10 is a result of increased entrance-region length within the header at high Re, as explained next. Since the theory used to design the TH-TD manifold assumes creeping flow conditions (Re→0), in that limit transverse momentum diffusion is infinitely fast relative to momentum advection, such that pressure drop due to locally high friction factor within the entrance region is insignificant in comparison with the header pressure-drop between successive diffuser channels. At finite Re, non-zero entrance length is produced within the header and within diffuser channels. For the present 0.50 mm diffuser channels with Re˜10 the entrance length xfa is only 0.50 mm×0.05×10=0.25 mm (assuming x_{fd}/L_{c}=0.05×Re, where L_{c} is the characteristic cross-sectional dimension upon which Re is based), which is insignificant for most diffuser channels since the central-channel length is L_{d}⁰=10 mm. However, Re at the inlet of one side of the header is 2.6-fold higher than the diffuser-channel Reynolds number due to its higher mean velocity than in diffuser channels. As a result, flow within the header has a proportionally larger entrance length of 0.65 mm, which is comparable to the 1.96-mm spacing between diffuser channels. Thus, based on entrance-region effects one would expect flow non-uniformity to arise from the exclusion of design feature A at high Re. These effects additionally explain why flow is promoted at the central diffuser channels of the SH-RD manifolds at sufficiently high Re (FIG. 8A).

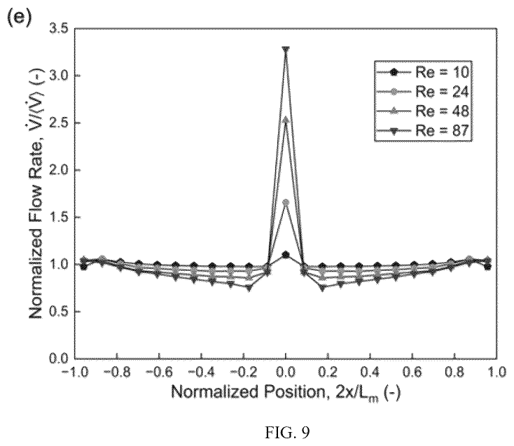

The resulting simulations with diffuser-channel Reynolds number between 10 and 100 show velocity distributions that are consistent with these conclusions. Flows with Re=10 and 24 produce pressure contours with roughly linear variation along the header, but a region of strong pressure gradients emerges near the manifold's inlet that disrupts the felicitous pressure distribution sought when posing the present creeping-flow design theory. This effect is exacerbated by further increasing Reynolds number, where the emergent high-pressure region biases flow to the central diffuser channel while starving other diffuser channels. Examination of the header region reveals that flow is routed to channels that are nearest to the center channel via a near-wall layer of moderate-velocity fluid, with the transverse extent of that layer being narrower for Re=87 than for Re=48. Concomitant with the narrowing of the near-wall flow, flow through the central diffuser channel is further promoted, as shown in FIG. 9.

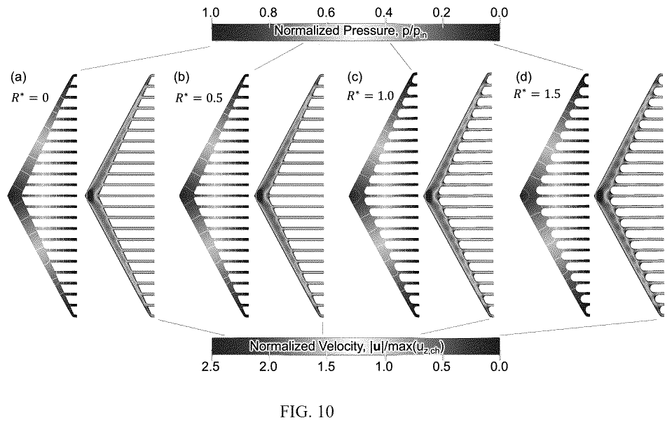

When incorporating the manifold in flow cells with fluid pumping from an external reservoir, experiments showed the steady-state flow uniformity at the exit plane of the diffuser may be disrupted in a deleterious fashion if bubbles of sufficient size and number are trapped within the manifold's header channel. To mitigate the effects of bubble trapping radii at the junctions between header channel and diffuser channels may be used. The effect of corner radius was simulated to determine what effect their presence would have on flow uniformity. FIG. 10 shows the corresponding pressure and velocity contours for Re=0.1 with corner radii of 0 mm, 0.25 mm, 0.5 mm, and 0.75 mm, corresponding to values of R* equal to 0.0, 0.5, 1.0, and 1.5when normalized by diffuser channel width. For R* less than or equal to unity (FIGS. 10A-10C), there is a negligible effect of corner radii on the resulting pressure distributions. While a larger corner radius (FIG. 10D) is shown to produce transverse pressure gradients in the vicinity of junctions a uniform longitudinal gradient is still produced in the manifold's header channel. Consequently, all cases simulated similar velocity distributions with uniform flow throughout diffuser channels, except for R* equal to 1.5 that shows a mild decrease in velocity along the diffuser channels at manifold tips.

Many other modifications of the embodiments above may be made to adapt a particular situation or material to the teachings without departing from the scope of the current disclosure. Therefore, it is intended that the present devices and systems not be limited to the particular embodiments disclosed, but that the disclosed devices and systems include all embodiments falling within the scope of the appended claims. Moreover, the advantages described herein are not necessarily the only advantages of the present disclosure and it is not necessarily expected that every embodiment of the present disclosure will achieve all of the advantages described.

1. A manifold comprising:
a header channel comprising a port configured to receive a fluid and having a plurality of openings disposed away from the port; and
a triangular-shaped diffuser comprising a plurality of channels, each channel of the plurality being in fluid communication with one of the openings of the header channel and terminating at a distal opening on an outlet plane, each channel extending a channel length, the channel length varying linearly along a length of the header channel,
wherein a downstream-most location of the header channel intersects the outlet plane at an angle ϕ,
wherein the header channel and the triangular-shaped diffuser are configured to provide a uniform flow velocity of the fluid at the distal openings during fluid flow.

2. The manifold of claim 1, wherein the header channel is configured to provide a linear pressure variation along the length of the header channel, the header channel having a tapered cross-section along the length thereof.

3. The manifold of claim 2, wherein the taper of the header channel is based upon a cubic-root variation of a position along the length of the header channel, a linear variation of a position along the length of the header channel, or a quartic-root variation of a position along the length of the header channel.

4. The manifold of claim 1, wherein a joint between one of the openings of the header channel and one of the channels of the triangular-shaped diffuser is radiused.

5. The manifold of claim 1, wherein the angle ϕ is based upon a width of the triangular-shaped diffuser at the outlet plane and a hydraulic conductance of the header channel.

6. The manifold of claim 1, wherein the plurality of channels are parallel and each channel of the plurality is equidistant from a neighboring channel.

7. The manifold of claim 6, wherein the angle ϕ is defined by
$${sin}^{- 1} ( \frac{{N}_{d} {G}_{d}}{2 {G}_{h}^{0}} ) ,$$
wherein N_{d} is a quantity of the plurality of channels, G_{d} is a hydraulic conductance of one of the plurality of channels, and Gₕ⁰ is a hydraulic conductance of the header channel at an upstream-most location of the header channel furthest from the outlet plane.

8. The manifold of claim 1, wherein the manifold is configured for fluid flow in either direction, wherein depending on the direction of flow the plurality of openings in the header channel are upstream or downstream of the port, the distal openings receive or discharge the fluid, and the port is configured to discharge the fluid from the header channel or receive the fluid into the header channel.

9. The manifold of claim 1, wherein the triangular-shaped diffuser is symmetric about a centerline extending between an upstream-most point of the header channel furthest from the outlet plane and a center point of the outlet plane such that a perimeter of the triangular-shaped diffuser forms an isosceles triangle.

10. The manifold of claim 1, wherein an edge of the triangular-shaped diffuser is perpendicular to the outlet plane, such that a perimeter of the triangular-shaped diffuser forms a right triangle.

11. A device comprising the manifold of claim 1, wherein the device is an electrochemical cell, a flow battery, a fuel cell, a heat exchanger, a microfluidic device, an electrolyzer, or a liquid or gas spraying or coating apparatus.

12. A manifold for directing a uniform flow of fluid comprising:
a header channel comprising a port and having a plurality of openings disposed away from the port, the header channel having a tapered cross-section along a length of the header channel; and
a triangular-shaped diffuser comprising a plurality of channels, each channel of the plurality being in fluid communication with one of the openings of the header channel and terminating at a distal opening on an outlet plane, each channel extending a channel length, the channel length varying linearly along a length of the header channel,
wherein a downstream-most location of the header channel intersects the outlet plane at an angle ϕ.

13. The manifold of claim 12, wherein the plurality of channels are parallel and each channel of the plurality is equidistant to a neighboring channel.

14. The manifold of claim 13, wherein the angle of the triangular-shaped diffuser is defined by
$${sin}^{- 1} ( \frac{{N}_{d} {G}_{d}}{2 {G}_{h}^{0}} ) ,$$
wherein N_{d} is a quantity of the plurality of channels, G_{d} is a hydraulic by conductance of one of the plurality of channels, and Gₕ⁰ is a hydraulic conductance of the header channel at an upstream-most location of the header channel furthest from the outlet zone.

15. The manifold of claim 12, wherein the manifold is configured for fluid flow in either direction, wherein depending on the direction of flow the plurality of openings in the header channel are upstream or downstream of the port, the distal openings receive or discharge the fluid, and the port is configured to discharge the fluid from the header channel or receive the fluid into the header channel.

16. A method of distributing fluid, the method comprising: delivering a fluid into the manifold of claim 12 whereby the fluid flows through the header channel with a linear variation in pressure along the length thereof, and the fluid exits the distal openings with a uniform flow velocity across the channels.

17. The method of claim 16, wherein the fluid flows at a Reynolds number of 10 or less in the manifold.

18. The method of claim 16, wherein the manifold distributes the fluid to an electrochemical cell, a flow battery, a fuel cell, a heat exchanger, a microfluidic device, an electrolyzer, liquid coating apparatus, or a liquid or gas spraying or coating apparatus.

19. The method of claim 16, comprising two of the manifolds, wherein a first of the manifolds distributes fluid uniformly into a first end of the device and a second of the manifolds collects fluid uniformly from a second send of the device.

20. A manifold for directing a uniform flow of fluid comprising:
a header channel comprising a port and having a plurality of openings disposed away from the port, the header channel having a tapered cross-section along a length of the header channel; and
a triangular-shaped diffuser comprising a porous material configured to provide flow pathways therethrough, the porous material having a permeability k_{d}, the flow pathways through the triangular-shaped diffuser being in fluid communication with the openings of the header channel and terminating at an outlet plane,
wherein a downstream-most location of the header channel intersects the outlet plane at an angle ϕ.
